(19) United States
(12) Patent Application Publication
(10) Pub. No.: US 2015/0284667 A1
(43) Pub. Date: Oct. 8, 2015

(54) ALCOHOLIC BEVERAGES WITH HEALTH-BENEFITTING AND PROTECTIVE CHARACTERISTICS

(71) Applicant: Cerebral Spirits Corporation, Topanga, CA (US)

(72) Inventors: Miles Matlock Edman, Westlake Village, CA (US); Michael Charles McCauley, Malibu, CA (US); Alexander Metzenbaum Sherwood, Topanga, CA (US)

(73) Assignee: Cerebral Spirits Corporation, Topanga, CA (US)

(21) Appl. No.: 14/248,119

(22) Filed: Apr. 8, 2014

(51) Int. Cl. C12G 3/04

(52) U.S. Cl. CPC C12G 3/04

(57) ABSTRACT

An alcoholic beverage and method for production thereof are provided. The alcoholic beverage includes ingredients that enhance the flavor and taste profile and the health-benefiting and protective characteristics of the alcoholic beverage. The alcoholic beverage may include at least one of L-theanine, resveratrol, and epigallocatechin in effective amounts.

### FIELD

The present application generally relates to alcoholic beverages and, more particularly, to alcoholic beverages including ingredients providing the alcoholic beverages with certain health-benefitting and protective properties.

### BACKGROUND

Humans have been consuming alcoholic beverages such as wine, beer, and spirits for thousands of years. Ethanol is a necessary ingredient of alcoholic beverages. Ethanol may have a few benefits for the body when consumed in moderate amounts. For example, ethanol is known to make blood less likely to clot, potentially reducing risk of heart attack and stroke. It is generally recognized that excessive consumption of alcohol is unhealthy for the body and may result in serious liver damage. Ethanol-based beverages are generally considered to be unhealthy by most of today's medical professionals and the only beverage having ethanol content above 3% that physicians have recommend to some patients for consumptions is red wine. Red wine is known for having a plethora of polyphenolic compounds, which are considered to have anti-oxidative, anti-aging, and anti-cardiac disease properties. Accordingly, there is some consensus in the medical field that consuming one or two glasses of red wine on a daily basis may provide a health benefit to the consumer.

While some consumers choose to consume red wine for its antioxidant properties, the average consumer of alcoholic beverages does not typically consume alcoholic beverages for the purpose of receiving health benefits, and many consumers of alcoholic beverages prefer products having a considerably higher ethanol content than present in red wine, for example, vodka, tequila, whisky, gin, rum, or the like for a number of reasons, one reason being to mix whichever flavor the consumers prefer to enjoy with ethanol. When ingested into the human body, ethanol is oxidized by alcohol dehydrogenase (ADH) in the liver into acetaldehyde, which is further converted to acetic acid by aldehyde dehydrogenase (ALDH) and is excreted from the body. When acetaldehyde, an alcohol metabolite, is not fully metabolized and accumulates in the body, it causes flushing, a sick feeling and other symptoms characteristic of the state of being “drunk,” which further leads to headache, nausea and other hangover symptoms. While red wine does have some health-benefitting properties as discussed above, neither red wine, nor any of the other presently known alcoholic beverages have ingredients that specifically protect the body from the negative effects of acetaldehyde or ethanol on the internal organs of the body.

Accordingly, it is desirable to enhance the health characteristics of alcoholic beverages and to provide a protective effect against the potentially harmful effects of ethanol in the alcoholic beverages on the body.

### SUMMARY

Generally, the present application describes formulations of alcoholic beverages that provide consumers with a healthier alternative to the alcoholic beverages presently available. In particular, the formulations of alcoholic beverages described herein provide a health benefit to the consumer by protecting the body from the harmful effects of ethanol and providing beneficial antioxidant compounds and the like. The alcoholic beverage formulations described herein may include natural ingredients including ethanol, resveratrol, epigallocatechin, L-theanine, and combinations thereof.

In one form, an alcoholic beverage includes L-theanine in an amount ranging from about 0.02 mg/ml and 2.8 mg/ml.

The alcoholic beverage may further include epigallocatechin in an amount ranging from about 0.02 mg/ml to about 2.9 mg/ml. In one form, the amount of epigallocatechin in the alcoholic beverage may range from about 0.02 mg/ml to about 0.6 mg/ml. In one form, the amount of epigallocatechin in the alcoholic beverage may range from about 0.06 mg/ml to about 0.5 mg/ml.

The alcoholic beverage may further include trans-resveratrol in an amount ranging from about 0.02 mg/ml to about 2.2 mg/ml. In one form, the amount of resveratrol in the alcoholic beverage may range from about 0.02 mg/ml to about 0.4 mg/ml. In one approach, the amount of trans-resveratrol in the alcoholic beverage may range from about 0.06 mg/ml to about 0.3 mg/ml.

In one approach, the alcoholic beverage may further include epigallocatechin in an amount ranging from about 0.02 mg/ml and 2.9 mg/ml, and resveratrol in an amount ranging from about 0.02 mg/ml and about 2.2 mg/ml.

The alcoholic beverage may include L-theanine in an amount ranging from about 0.06 mg/ml to about 0.8 mg/ml. In one form, the amount of L-theanine in the alcoholic beverage may range from about 0.06 mg/ml to about 0.3 mg/ml.

The alcoholic beverage may include from about 3% ethanol to about 99% ethanol and may be selected from a group consisting of: vodka, whisky, rum, tequila, gin, cognac, wine, and beer.

In one form, the alcoholic beverage further includes Coenzyme Q10 in an amount ranging from about 0.06 mg/ml to about 2.5 mg/ml.

In one form, the alcoholic beverage further includes at least one omega-3 fatty acid ranging from about 1mg/ml to about 25 mg/ml. The omega-3 fatty acid may be eicosapentaenoic acid (EPA), docosahexaenoic acid (DHA), or a combination thereof.

In one form, the alcoholic beverage further includes dihydromyricetin in an amount ranging from about 0.06 mg/ml to about 2.2 mg/ml.

In one form, the alcoholic beverage further includes potassium ranging in an amount ranging from about 0.06 mg/ml to about 5 mg/ml.

In one form, the alcoholic beverage further includes ferulic acid in an amount ranging from about 0.03 mg/ml to about 3mg/ml.

In one form, the alcoholic beverage further includes glucosamine in an amount ranging from about 0.04 mg/ml to about 10 mg/ml.

In one form, the alcoholic beverage further includes at least one phytosterol in an amount ranging from about 0.05 mg/ml to about 6 mg/ml.

In one form, the alcoholic beverage further includes chlorophyll in an amount ranging from about 0.06 mg/ml to about 7 mg/ml.

In one form, the alcoholic beverage further includes spirulina in an amount ranging from about 0.07 mg/ml to about 60 mg/ml.

In one form, the alcoholic beverage further includes 5-hydroxytryptophan in an amount ranging from about 0.02 mg/ml to about 2.2 mg/ml.

The alcoholic beverages described herein advantageously provide health benefits to the consumers in that the alcoholic beverages include ingredients that provide a protective effect against the potentially harmful effects of ethanol on the internal organs of a human body. In addition, the ingredients present in the alcoholic beverages described herein provide further health benefits such as anti-oxidant, anti-aging, and other beneficial properties. Further, the combination of the ingredients of he alcoholic beverage formulations described herein advantageously have better aroma and taste and have significantly lower unpleasant bite and after burn when consumed, and, based on consumer testing, significantly overall outperform an average vodka on the market today.

The embodiments of the present invention discussed in more detail below are not directed just to a spirit, but is also broadly directed to a way of manipulating liquor to be transformed to a new type of beverage that is superior in terms of health. Currently available scientific literature suggests that alcohol is unhealthy. This is based on studies showing that when metabolized in the liver, alcohol turns into multiple by-products, of which acetaldehyde is the most harmful. However, when alcohol is consumed in moderation, studies have shown that alcohol can have positive effects on health. While very few consume alcohol for its health benefits, many people consume red wine for its perceived health benefits, but are otherwise greatly limited in their choice of an alcoholic beverage having health benefits. Currently the health benefits offered by alcoholic beverages are limited to those that occur naturally. The present inventors have added various combinations of additional ingredients to remove this shortcoming in both the medium in which the alcohol is consumed, as well as the overall benefits the alcohol can offer. For example only, by adding L-theanine the present inventors have created an alcoholic composition and/or beverage which, when consumed, helps to reduce the negative effects of acetaldehyde on the liver. As such, the present inventors have created an alternative option for people mindful of alcohol's negative effects, but still enjoy drinking.

These and other advantages will be apparent upon consideration of the present specification.

### DETAILED DESCRIPTION

The alcoholic beverage formulations and method of producing thereof described herein provide consumers of alcoholic beverages such as beer, wine, whisky, rum, tequila, gin, vodka, and the like with an alternative that has more health benefits than conventional alcoholic beverages. Generally, an alcoholic beverage formulation may include effective amounts of at least one of L-theanine, resveratrol, epigallocatechin, or combinations thereof. These ingredients provide the alcoholic beverages described herein with various beneficial and advantageous properties that may protect the consumer from the harmful effects of ethanol and that may have other health benefits.

The alcoholic beverages suitable for use in the formulations described herein may be beers, wines and spirits that include ethanol in the range of 6 proof (i.e., 3% ethanol content) to 198 proof (i.e., 99% ethanol content). Some exemplary alcoholic beverages suitable for incorporating the formulations described herein may include vodka, tequila, whisky, gin, rum, wine, scotch, beer, or the like. It will be appreciated that other alcoholic beverages not expressly mentioned herein may also be advantageously used in combination with the ingredients of the present formulations, such as resveratrol, L-theanine, and epigallocatechin.

Resveratrol is a naturally occurring phenolic compound produced by several plants, for example, Japanese knotweed (Polygonum cuspidatum) and grapes (found in the skin of red grapes). For purposes of this application, the term resveratrol will be understood to mean all enantiomers of resveratrol, including trans-resveratrol and cis-resveratrol. Resveratrol may also be produced by chemical and/or biochemical synthesis. Resveratrol has been found to have various health-enhancing and/or protective properties, and various studies have been performed to determine the effect of resveratrol when consumed by humans, leading to association of resveratrol with various beneficial properties in relation to health of humans. In particular, resveratrol is believed to be beneficial to the functioning of the heart and cardiac system and extending the life of human cells. Resveratrol is also believed to provide anti-aging and antioxidant effects and has been found by the present inventors to have an ability to reduce the burn at the back of the throat that typically follows alcoholic beverage consumption. Resveratrol may be naturally present in amounts ranging from about 0.002 mg/ml to about 0.007 mg/ml in most red wines, and may be present in amounts ranging from about 0.002 mg/ml to about 0.01 mg/ml in Spanish red wines.

Theanine, also known as gamma-glutamylethylamide or 5-N-ethyl-glutamine, is an amino acid and a glutamic acid analog primarily found in tea, for example, Camellia sinensis. The L-enantiomer of theanine, namely, L-theanine, is a form of theanine that is found in tea. L-theanine was discovered as a constituent of green tea in 1949 and has been associated with being responsible with the unique taste and flavor of green tea infusions. L-theanine generally may provide a bitter-sweet flavor which may compliment and/or counteract the flavor of various components in an alcoholic beverage (e.g., epigallocatechins). To the present inventors' knowledge, L-theanine is not conventionally added to alcoholic beverages.

L-theanine has also been found to have protective properties for liver function. For example, while ethanol is known to be toxic to liver cells, L-theanine has been shown to significantly protect hepatocytes against ethanol-induced cell cytotoxicity. L-theanine has been also shown to have a direct influence on brain activity, such as reducing stress.

Epigallocatechin, and more specifically, epigallocatechin gallate (an ester of epigallocatechin and gallic acid), is the most abundant catechin in tea and is a potent antioxidant polyphenolic compound which is believed to be responsible for the health benefits associated with the consumption of green tea that may have therapeutic applications in the treatment of many disorders including cancer. For purposes of this application, the term epigallocatechin will be understood to mean all enantiomers of epigallocatechin as well as epigallocatechin gallate. Increasing evidence has suggested that epigallocatechin exhibits anti-inflammatory, anti-oxidant and immunosuppressive effects. Epigallocatechin is found mainly in white tea, green tea, and, in smaller quantities, black tea. Epigallocatechin is also found in various vegetables, nuts, as well as carob powder. To the present inventors' knowledge, epigallocatechin is not conventionally added to alcoholic beverages.

The present inventors discovered that adding one or more of resveratrol, L-theanine, and epigallocatechin to ethanol unexpectedly results in an alcoholic beverage having significantly improved health profile characteristics, as well as improved taste and aroma characteristics. Without wishing to be limited by theory, the presence of one or more of resveratrol, L-theanine, and epigallocatechin in any alcoholic beverage is believed to reduce the damaging effect of ethanol on the internal organs of the body (e.g., liver) and simultaneously provides health benefits, including antioxidant properties, thereby providing a healthier alcoholic beverage. Also, the addition of all three of L-theanine, resveratrol, and epigallocatechin to ethanol unexpectedly results in a cumulative protective effect. Further, as shown in Example 1, below, the presence of resveratrol, L-theanine, and epigallocatechin in an exemplary alcoholic beverage improves various taste, aroma, and drinking experience properties of the alcoholic beverage, making the alcoholic beverage preferable to the conventional alcoholic beverages presently available.

In one exemplary form, an alcoholic beverage includes L-theanine in an amount ranging from about 0.02 mg/ml and 2.8 mg/ml. More specifically, in one form, an alcoholic beverage may include about 1 to about 125 mg (i.e., about 0.02 mg/ml to about 2.8 mg/ml) L-theanine per 45 milliliters of the alcoholic beverage. Preferably, the alcoholic beverage may include about 3 to about 35 mg (about 0.06 mg/ml to about 0.8 mg/ml) of L-theanine per 45 milliliters of the alcoholic beverage. Even more preferably, the alcoholic beverage may include about 3 to about 12 mg (about 0.06 mg/ml to about 0.3 mg/ml) of L-theanine per 45 milliliters of the alcoholic beverage. Without wishing to be limited by theory, an alcoholic beverage including solely L-theanine as its additive may not provide as many protective and health benefits as an alcoholic beverage including resveratrol, L-theanine, and epigallocatechin, but such a formulation may be suitable to provide an alcoholic beverage having improved health benefit characteristics as compared to the conventional alcoholic beverages (e.g., red wine) available on the market.

In one form, the alcoholic beverage, in addition to L-theanine (e.g., in an amount ranging from about 0.02 mg/ml and 2.8 mg/ml), may include about 1 to about 100 mg (i.e., about 0.02 mg/ml to about 2.2 mg/ml) of resveratrol per 45 milliliters of the alcoholic beverage. Forty-five milliliters is typically considered one shot for spirits such as vodka, tequila, gin, or the like. Preferably, the alcoholic beverage may include about 1 to about 18 mg (i.e., about 0.02 mg/ml to about 0.4 mg/ml) of resveratrol per 45 milliliters of the alcoholic beverage. Even more preferably, the alcoholic beverage may include about 3 to about 12 mg (about 0.06 mg/ml to about 0.3 mg/ml) of resveratrol per 45 milliliters of the alcoholic beverage. Without wishing to be limited by theory, an alcoholic beverage including L-theanine and resveratrol may not provide as many protective and health benefits as an alcoholic beverage including resveratrol, L-theanine, and epigallocatechin, but such a formulation may provide a cumulative protective effect compared to a formulation including only L-theanine and results in an alcoholic beverage having improved health benefit characteristics as compared to the conventional alcoholic beverages such as red wine available on the market.

In one form, an alcoholic beverage, in addition to the L-theanine (e.g., in an amount ranging from about 0.02 mg/ml and 2.8 mg/ml) but without resveratrol, may include about 1 to about 130 mg (i.e., about 0.02 mg/ml to about 2.9 mg/ml) of epigallocatechin per 45 milliliters of the alcoholic beverage. Preferably, the alcoholic beverage may include about 1 to about 25 mg (i.e., about 0.02 mg/ml to about 0.6 mg/ml) of epigallocatechin per 45 milliliters of the alcoholic beverage. Even more preferably, the alcoholic beverage may include about 3 to about 24 mg (about 0.06 mg/ml to about 0.5 mg/ml) of epigallocatechin per 45 milliliters of the alcoholic beverage. Without wishing to be limited by theory, an alcoholic beverage including L-theanine and epigallocatechin but not resveratrol may not provide as many protective and health benefits as an alcoholic beverage including resveratrol, L-theanine, and epigallocatechin, but such a formulation may provide a cumulative protective effect compared to a formulation including only L-theanine and results in an alcoholic beverage having improved health benefit characteristics as compared to the conventional alcoholic beverages such as red wine available on the market.

In one alternative approach, an alcoholic beverage may include resveratrol (without L-theanine and without epigallocatechin) in an amount ranging from about 0.02 mg/ml and 2.2 mg/ml. The amount of resveratrol may range from about 0.02 mg/ml to about 0.4 mg/ml. In one form, the amount of resveratrol ranges from about 0.06 mg/ml to about 0.3 mg/ml. The amounts of resveratrol (0.02 mg/ml to 2.2 mg/ml) present in the alcoholic beverages described herein are higher than the amounts of resveratrol (0.002 mg/ml to about 0.007 mg/ml) present in most red wines, providing the consumers of the alcoholic beverages described herein with even more health benefits of resveratrol consumption than most red wines. Without wishing to be limited by theory, an alcoholic beverage including solely resveratrol as an antioxidant may not provide as many protective and health benefits as an alcoholic beverage including resveratrol, L-theanine, and epigallocatechin, but such a formulation includes significantly more resveratrol than red wine and may be suitable to provide an alcoholic beverage having improved health benefit characteristics as compared to the conventional alcoholic beverages such as red wine available on the market.

In one approach, an alcoholic beverage may include epigallocatechin (without L-theanine and without resveratrol) in an amount ranging from about 0.02 mg/ml and 2.9 mg/ml. The amount of epigallocatechin may range from about 0.02 mg/ml to about 0.6 mg/ml. In one form, the amount of epigallocatechin ranges from about 0.06 mg/ml to about 0.5 mg/ml. Without wishing to be limited by theory, an alcoholic beverage including solely epigallocatechin as the antioxidant may not provide as many protective and health benefits as an alcoholic beverage including resveratrol, L-theanine, and epigallocatechin, but such a formulation may be suitable to provide an alcoholic beverage having improved health benefit characteristics as compared to the conventional alcoholic beverages available on the market.

In another optional form, the alcoholic beverage may include all three ingredients together, namely, L-theanine in an amount ranging from about 0.02 mg/ml and 2.8 mg/ml, resveratrol in an amount ranging from about 0.02 mg/ml and about 2.2 mg/ml, and epigallocatechin in an amount ranging from about 0.02 mg/ml and 2.9 mg/ml. Without wishing to be limited by theory, an alcoholic beverage including L-theanine and epigallocatechin and resveratrol provides an unexpected cumulative protective effect as compared to alcoholic beverages containing only one or even two of resveratrol, L-theanine, or epigallocatechin, and has significantly improved health benefit characteristics as compared to conventional alcoholic beverages such as red wine available on the market. It will be appreciated that the amounts of the resveratrol, L-theanine, and epigallocatechin are described herein by way of example and not limitation, and that smaller or larger amounts of these three ingredients may be advantageously used in an alcoholic beverage according to the principles set forth herein.

Resveratrol, L-theanine, and epigallocatechin are all ethanol soluble and it has been found by the present inventors that the presence of resveratrol, L-theanine, and epigallocatechin in an alcoholic beverage does not significantly change the appearance and consistency of the alcoholic beverage, but advantageously improves at least the taste and flavor profile of such a beverage as discussed in more detail in Example 1 below.

In the event that consistency and/or flavor profile of an alcoholic beverage is noticeably affected by the addition of the resveratrol, L-theanine, and epigallocatechin in the amounts described herein, certain additives and flavorants may be added to the alcoholic beverage to adjust the consistency and/or flavor of the alcoholic beverage to a desired profile. Exemplary flavoring and other additives for use in the compositions and beverages described herein include, for example, vanilla, citrus, blackberry, blueberry, or the like. While the formulations described herein include exemplary flavoring additives for use in the compositions and beverages including resveratrol, L-theanine, and epigallocatechin, and combinations thereof, it will be appreciated that other ingredients having potential health benefits and/or protective properties may be advantageously added to the formulation. Examples of some antioxidants and/or other ingredients that may be added to the formulation are described below.

In one optional embodiment, in addition to L-theanine (e.g., in an amount ranging from about 0.02 mg/ml and 2.8 mg/ml), the alcoholic beverage may include about 2.7 mg to about 112 mg (0.06 mg/ml to about 2.5 mg/ml) of Coenzyme Q10 (CoQ10) per 45 milliliters of the alcoholic beverage. It will be appreciated that CoQ10 may be added to an alcoholic beverage containing only resveratrol or only epigallocatechin, or any combination of L-theanine, resveratrol, and epigallocatechin.

Coenzyme Q10, also known as ubiquinone, ubidecarenone, coenzyme Q, and abbreviated at times to CoQ10 is an oil-soluble, vitamin-like substance that is present in most eukaryotic cells, primarily in the mitochondria. The antioxidant nature of CoQ10 is thought to be derived from its energy carrier function. CoQ10 is known, for example, to inhibit lipid peroxidation by preventing the production of lipid peroxyl radicals (LOO); protect not only lipids but also proteins from oxidation; regenerating vitamin E from the a-tocopheroxyl radical; protect mitochondrial DNA from oxidative stress; and prevent oxidation of LDL, which may provide benefit in cardiovascular diseases. Without wishing to be limited by theory, an alcoholic beverage including one or more of L-theanine, resveratrol, epigallocatechin, and CoQ10 may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 45 mg to about 1125 mg (1 mg/ml to about 25 mg/ml) of omega 3 fatty acids per 45 milliliters of the alcoholic beverage. It will be appreciated that omega 3 fatty acids may be added to an alcoholic beverage containing only resveratrol or only epigallocatechin, or any combination of L-theanine, resveratrol, and epigallocatechin.

Omega-3 fatty acids are polyunsaturated fatty acids with a double bond (C═C) at the third carbon atom from the end of the carbon chain. The three types of omega-3 fatty acids involved in human physiology are alpha-linolenic acid or ALA, eicosapentaenoic acid or EPA, and docosahexaenoic acid or DHA. Common sources of animal omega-3 EPA and DHA fatty acids include fish oils, egg oil, squid oils, krill oil, while some plant oils contain the omega 3 ALA fatty acid such as seabuckthorn seed and berry oils, clary sage seed oil, algal oil, flaxseed oil, Sacha Inchi oil, Echium oil, and hemp oil. Omega-3 fatty acids are vital for normal metabolism and are considered essential fatty acids, meaning that they cannot be synthesized by the human body. EPA and DHA are thought to have protective effects for the function of the nervous system, cardiovascular system, and possibly against neurodegenerative and immune disease. Without wishing to be limited by theory, an alcoholic beverage including L-theanine, resveratrol, and epigallocatechin, at least one omega-3 fatty acid may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 2.7 mg to about 100 mg (0.06 mg/ml to about 2.2 mg/ml) of dihydromyricetin per 45 milliliters of the alcoholic beverage. It will be appreciated that dihydromyricetin may be added to an alcoholic beverage containing only resveratrol or only epigallocatechin, or any combination of L-theanine, resveratrol, and epigallocatechin.

Dihydromyricetin, also known as ampelosin, is a flavanonol, a type of flavonoid. It can be found in Cedrus deodara or in the Japanese raisin tree Hovenia dulcis. It is also found in Erythrophleum africanum. The compound is thought to have hepatoprotective properties and may counteract the effects of alcohol in the brain and provide relief against hangovers. Without wishing to be limited by theory, an alcoholic beverage including one or more of L-theanine, resveratrol, epigallocatechin, and dihydromyricetin may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 2.7 mg to about 225 mg (0.06 mg/ml to about 5 mg/ml) of potassium per 45 milliliters of the alcoholic beverage. It will be appreciated that potassium may be added to an alcoholic beverage containing only resveratrol or only epigallocatechin, or any combination of L-theanine, resveratrol, and epigallocatechin.

Potassium is the eighth or ninth most common element in the human body and is known to be important in brain cell and nerve function, muscle action, as well as maintaining osmotic balance between cells and interstitial fluid. Without wishing to be limited by theory, an alcoholic beverage including one or more of L-theanine, resveratrol, epigallocatechin, and potassium may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 1.35 mg to about 135 mg (0.03 mg/ml to about 3 mg/ml) of ferulic acid per 45 milliliters of the alcoholic beverage. It will be appreciated that ferulic acid may be added to an alcoholic beverage containing only resveratrol or only epigallocatechin, or any combination of L-theanine, resveratrol, and epigallocatechin.

Ferulic acid is a hydroxycinnamic acid and is an abundant phenolic phytochemical found in plant cell wall components such as arabinoxylans as covalent side chains. Ferulic acid, is known to be an antioxidant and is reactive toward free radicals (e.g., reactive oxygen species). As such, ferulic acid may have a protective effect against ROS-caused DNA damage, cancer, accelerated cell aging. Ferulic acid has been shown in animal studies to have direct antitumor activity against breast cancer and liver cancer and may have pro-apoptotic effects in cancer cells, thereby leading to their destruction. Without wishing to be limited by theory, an alcoholic beverage including one or more of L-theanine, resveratrol, epigallocatechin, and ferulic acid may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 1.8 mg to about 450 mg (0.04 mg/ml to about 10 mg/ml) of glucosamine per 45 milliliters of the alcoholic beverage. It will be appreciated that glucosamine may be added to an alcoholic beverage containing only resveratrol or only epigallocatechin, or any combination of L-theanine, resveratrol, and epigallocatechin.

Glucosamine is an amino sugar and is commonly used to support the structure and function of joints for people suffering from osteoarthritis. Without wishing to be limited by theory, an alcoholic beverage including one or more of L-theanine, resveratrol, epigallocatechin, and glucosamine may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 2.25 mg to about 270 mg (0.05 mg/ml to about 6 mg/ml) of a phytosterol per 45 milliliters of the alcoholic beverage. It will be appreciated that one or more phytosterols may be added to an alcoholic beverage containing only resveratrol or only epigallocatechin, or any combination of L-theanine, resveratrol, and epigallocatechin.

Phytosterols include sterols and stanols, occur in plants, and are steroid compounds that are similar to cholesterol. Phytosterols have been shown to have cholesterol-lowering efficacy and are thought to have anti-carcinogenic properties. Without wishing to be limited by theory, an alcoholic beverage including one or more of L-theanine, resveratrol, epigallocatechin, and one or more phytosterols may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 2.7 mg to about 315 mg (0.06 mg/ml to about 7 mg/ml) of chlorophyll per 45 milliliters of the alcoholic beverage. It will be appreciated that chlorophyll may be added to an alcoholic beverage containing only resveratrol or only epigallocatechin, or any combination of L-theanine, resveratrol, and epigallocatechin.

Chlorophyll is a green pigment found in plants and cyanobacteria. It is commonly used as a food colorant. Without wishing to be limited by theory, an alcoholic beverage including one or more of L-theanine, resveratrol, epigallocatechin, and chlorophyll may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 3.15 mg to about 2700mg (0.07 mg/ml to about 60 mg/ml) of spirulina per 45 milliliters of the alcoholic beverage. It will be appreciated that spirulina may be added to an alcoholic beverage containing only resveratrol or only epigallocatechin, or any combination of L-theanine, resveratrol, and epigallocatechin.

Spirulina is a cyanobacterium and is typically made from two species of cyanobacteria, namely, Arthrospira platensis and Arthrospira maxima. Spirulina is a complete protein and contains all essential amino acids and is known to be rich in a variety of nutrients, including, for example, vitamin A, Thiamine, Riboflavin, Vitamin B6, Niacin, linoleic acid, stearidonic acid, fish oils, as well as, potassium, calcium, and zinc. Without wishing to be limited by theory, an alcoholic beverage including one or more of L-theanine, resveratrol, epigallocatechin, and spirulina may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

In one optional embodiment, in addition to L-theanine (e.g., in an amount ranging from about 0.02 mg/ml and 2.8 mg/ml), the alcoholic beverage may include about 1 mg to about 100 mg (0.02 mg/ml to about 2.2 mg/ml) of 5-HTP per 45 milliliters of the alcoholic beverage. It will be appreciated that 5-HTP may be added to an alcoholic beverage containing only resveratrol or only epigallocatechin, or any combination of L-theanine, resveratrol, and epigallocatechin.

5-HTP, also known as 5-hydroxytryptophan or oxitriptan is a naturally occurring amino acid and is a known precursor of neurotransmitters serotonin and melatonin. 5-HTP is known for its uses as an antidepressant, appetite suppressant, and sleep aid. Without wishing to be limited by theory, an alcoholic beverage including one or more of L-theanine, resveratrol, epigallocatechin, and 5-HTP may provide more health benefits than an alcoholic beverage including resveratrol, L-theanine, and epigallocatechin, and results in an alcoholic beverage having improved health benefit characteristics as compared to the conventional alcoholic beverages such as red wine available on the market.

A method of producing a ready-to-drink alcoholic beverage is also provided. The method includes adding to the alcoholic beverage one or more of resveratrol in an amount ranging from about 0.02 mg/ml and about 2.2 mg/ml, L-theanine in an amount ranging from about 0.02 mg/ml and 2.8 mg/ml, and epigallocatechin in an amount ranging from about 0.02 mg/ml to about 2.9 mg/ml. It will be appreciated that the resveratrol, L-theanine, and epigallocatechin may be added to the alcoholic beverage during production of the alcoholic beverage, or may be added as a dissolvable powder or via an alternative suitable delivery method post production.

The method of producing an alcoholic beverage as described herein may include adding to the alcoholic beverage an amount of the resveratrol ranging from about 0.02 mg/ml to about 0.4 mg/ml. In one approach, the method may include adding to the alcoholic beverage an amount of resveratrol ranging from about 0.06 mg/ml to about 0.3 mg/ml.

The method of producing an alcoholic beverage as described herein may further include adding to the alcoholic beverage an amount of the L-theanine ranging from 0.06 mg/ml to about 0.8 mg/ml. In one form, the method may further include adding to the alcoholic beverage an amount of L-Theanine ranging from about 0.06 mg/ml to about 0.3 mg/ ml.

The method of producing an alcoholic beverage as described herein may further include adding to the alcoholic beverage an amount of the epigallocatechin ranging from about 0.02 mg/ml to about 0.6 mg/ml. In one form, the method may further include adding to the alcoholic beverage an amount of epigallocatechin ranging from about 0.06 mg/ml to about 0.5 mg/ml.

It will be appreciated that the method of producing an alcoholic beverage as described herein may include adding to the alcoholic beverage any one or more of L-theanine, resveratrol, epigallocatechin, coenzyme Q10, omega-3 fatty acids, dihydromyricetin, potassium, ferulic acid, glucosamine, phytosterol, chlorophyll, 5-hydroxytryptophan, or combinations thereof.

The following example illustrates exemplary formulations of the alcoholic beverages according to the principles described herein and results obtained during single blind and double blind taste test studies aimed at obtaining various characteristics of the alcoholic beverages noticeable by consumers during the taste tests.

### EXAMPLE

Four exemplary alcoholic beverage compositions were prepared according to the formulations shown in Table 1 below. Amounts of the listed ingredients in the alcoholic beverages are listed in milligrams per 45ml (one and one half ounce) of an ethanol beverage (in this example, vodka), which is generally agreed as representing a typical shot of such a beverage.

TABLE 1
Alcoholic Beverage Formulations Used in the Studies.

| Formulation | L-Theanine | Trans-Resveratrol | EGC |
|---|---|---|---|
| A | 12 mg | 6 mg | 24 mg |
| B | 6 mg | 12 mg | 6 mg |
| C | 3 mg | 3 mg | 3 mg |
| D | 0 mg | 0 mg | 0 mg |
| (conventional | | | |
| vodka) | | | |

Several studies were performed with a group of fifteen human subjects where the alcoholic beverages having the formulations indicated in Table 1 were orally administered to the subjects, followed by a questionnaire that provided the subject with an opportunity to assess various characteristics of each of the formulations, namely, appearance, aroma, taste, bite (i.e., immediate burning sensation), after burn, and comparison to average vodka.

The characteristics of the formulations were assessed by the subjects on a numerical scale, with 1 being the worst and 10 being the best. Five of the subjects participated in a single blind study, i.e., where the subjects were aware of which formulation belongs to the control formulation D and which formulations belong to the inventive formulations A-C. Ten of the subjects participated in a double blind study where the subjects were not aware of which formulation belongs to the control formulation D and which formulations belong to the inventive formulations A-C. This was done in an attempt to eliminate any subjective bias that the subjects may have when participating in a single blind study.

A table showing the average taste assessment provided by the fifteen subjects appears below.

TABLE 2

| | | | | | After | |
|---|---|---|---|---|---|---|
| Formulation | Appearance | Aroma | Taste | Bite | Burn | Comparison |
| A | 100 | 91 | 101 | 87 | 89 | 97 |
| B | 76 | 94 | 101 | 98 | 94 | 94 |
| C | 88 | 94 | 89 | 90 | 94 | 103 |
| D | 100 | 64 | 73 | 59 | 68 | 78 |

As can be seen above in Table 2, the exemplary inventive beverages A-C were consistently assessed by the test subjects to have significantly better aroma and taste. In addition, the exemplary inventive beverages A-C were consistently assessed by the test subjects to have significantly less unpleasant bite and after burn as compared to the control beverage D. Accordingly, the exemplary inventive alcoholic beverages A-C were believed by the test subjects to be significantly more preferable for consumption over the control alcoholic beverage D (which was an average conventional vodka). In addition, the exemplary inventive beverages A-C have significantly improved health characteristics and better protective properties for the consumers as discussed in more detail above.

The matter set forth in the foregoing description is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An alcoholic beverage comprising L-theanine in an amount ranging from about 0.02 mg/ml and 2.8 mg/ml.

2. The beverage of claim 1, further comprising epigallocatechin in an amount ranging from about 0.02 mg/ml and 2.9 mg/ml.

3. The beverage of claim 1, further comprising resveratrol in an amount ranging from about 0.02 mg/ml and about 2.2 mg/ml.

4. The beverage of claim 3, wherein the amount of resveratrol ranges from about 0.02 mg/ml to about 0.4 mg/ml.

5. The beverage of claim 3, wherein the amount of resveratrol ranges from about 0.06 mg/ml to about 0.3 mg/ml.

6. The beverage of claim 1, further comprising epigallocatechin in an amount ranging from about 0.02 mg/ml and 2.9 mg/ml and resveratrol in an amount ranging from about 0.02 mg/ml and about 2.2 mg/ml.

7. The beverage of claim 1, wherein the amount of L-theanine ranges from about 0.06 mg/ml to about 0.8 mg/ml.

8. The beverage of claim 1, wherein the amount of L-theanine ranges from about 0.06 mg/ml to about 0.3 mg/ml.

9. The beverage of claim 2, wherein the amount of epigallocatechin ranges from about 0.02 mg/ml to about 0.6 mg/ml.

10. The beverage of claim 2, wherein the amount of epigallocatechin ranges from about 0.06 mg/ml to about 0.5 mg/ml.

11. The beverage of claim 1, wherein the ready-to-drink alcoholic beverage comprises from about 3% ethanol to about 99% ethanol and is selected from a group consisting of:
vodka, whisky, rum, tequila, gin, cognac, wine, and beer.

12. The beverage of claim 1, further comprising coenzyme Q10 in an amount ranging from about 0.06 mg/ml to about 2.5 mg/ml.

13. The beverage of claim 1, further comprising at least one omega-3 fatty acid ranging from about 1mg/m1 to about 25 mg/ml, wherein the at least one omega-3 fatty acid is eicosapentaenoic acid (EPA), docosahexaenoic acid (DHA), or a combination thereof.

14. The beverage of claim 1, further comprising dihydromyricetin in an amount ranging from about 0.06 mg/ml to about 2.2 mg/ml.

15. The beverage of claim 1, further comprising potassium ranging in an amount ranging from about 0.06 mg/ml to about 5 mg/ml.

16. The beverage of claim 1, further comprising ferulic acid in an amount ranging from about 0.03 mg/ml to about 3mg/ml.

17. The beverage of claim 1, further comprising glucosamine in an amount ranging from about 0.04 mg/ml to about 10 mg/ml.

18. The beverage of claim 1, further comprising at least one phytosterol in an amount ranging from about 0.05 mg/ml to about 6 mg/ml.

19. The beverage of claim 1, further comprising chlorophyll in an amount ranging from about 0.06 mg/ml to about 7 mg/ml.

20. The beverage of claim 1, further comprising one of spirulina in an amount ranging from about 0.07 mg/ml to about 60 mg/ml and 5-hydroxytryptophan in an amount ranging from about 0.02 mg/ml to about 2.2 mg/ml.
